(19) United States
(12) Patent Application Publication
(10) Pub. No.: US 2016/0205957 A1
(43) Pub. Date: Jul. 21, 2016

(54) ION IRRADIATION APPARATUS, AND METHOD IN WHICH ION IRRADIATION APPARATUS IS APPLIED TO FOOD REQUIRING STORAGE BY REFRIGERATION

(71) Applicant: SHARP KABUSHIKI KAISHA, Osaka-shi, Osaka (JP)

(72) Inventors: Misaki IZU, Osaka-shi (JP); Kazuharu DATE, Osaka-shi (JP); Kouji HORIKAWA, Osaka-shi (JP); Kazuya SAKASHITA, Osaka-shi (JP); Hideki MIYAKE, Osaka-shi (JP)

(21) Appl. No.: 14/913,714

(22) PCT Filed: Feb. 27, 2014
(86) PCT No.: PCT/JP2014/054849

§ 371 Date: Feb. 23, 2016

(30) Foreign Application Priority Data
Aug. 29, 2013 (JP) 2013-178293

(51) Int. Cl. A23B 4/015

(52) U.S. Cl. CPC A23B 4/015; A23V 2002/00

(57) ABSTRACT

With a method of storing meat stored in a refrigerator or a freezer after a lump of meat is prepared into small portions, which includes irradiating the meat with positive ions and negative ions before storage in the refrigerator or the freezer, a method of extending a durable life of food requiring storage by refrigeration, a method of suppressing growth of fungi developed at a surface of food requiring storage by refrigeration, and an ion irradiation apparatus which can suitably be used for these methods, a method allowing suppression of growth of fungi adhering to food (in particular, meat) requiring storage by refrigeration, a method of thereby extending a durable life of food requiring storage by refrigeration, and an apparatus which can suitably be used for these methods are provided.

### TECHNICAL FIELD

The present invention relates to a method of storing meat, a method of extending a durable life of food requiring storage by refrigeration, and a method of suppressing growth of fungi developed at a surface of food requiring storage by refrigeration. In addition, the present invention relates to an ion irradiation apparatus which can suitably be used for these methods according to the present invention.

### BACKGROUND ART

In stores handling food such as supermarkets, a durable life particularly of meat is important from a point of view of safety. This durable life is highly relevant to perishing of food. Even food of which surface is substantially free from microorganisms in an initial stage is contaminated by transfer of fungi to the surface from machines or human hands during food processing. As fungi adhere, the fungi grow at the surface of food and the food perishes. Therefore, the number of fungi at the surface or in the inside of food is defined as an index, and many stores count the number of fungi. As a scale of stores is large, noticeable reduction in cost can be achieved by extending a durable life even by one day, and hence efforts for reducing the number of fungi adhering to food have conventionally been made.

In order to extend a durable life of food, a raw material small in initial number of fungi is used and food is processed at a location where sanitary conditions are controlled well in order to prevent contamination during food processing. In addition, perishing can be retarded by storage for a certain period of time at a low temperature such as refrigeration so as to suppress growth of fungi adhering to the surface of food. Some fungi, however, love a low temperature, and an effect of suppression of growth cannot be exhibited even by refrigeration in some cases.

For example, Japanese Patent Laying-Open No. 5-176732 (PTD 1) discloses a food storage method of ionizing air and storing food in an ionized air environment. In the method disclosed in PTD 1, an ion generation apparatus is placed in a refrigerator and various types of food are put into an environment in which negatively ionized air is constantly produced, and an experiment for determining change in number of living fungi as compared with a case of storage in a common refrigerator is conducted. According to such a method disclosed in PTD 1, contamination with or growth of germs or microorganisms adhering to food is certainly suppressed and a period for which food can be stored is extended. Negatively ionized air, however, should constantly be produced, and hence cost is high and electric power is consumed. In addition, some food is dried by constant impingement with negatively ionized air and may lose flavor.

### CITATION LIST

### Patent Document

### PTD 1: Japanese Patent Laying-Open No. 5-176732

### SUMMARY OF INVENTION

### Technical Problem

The present invention was made to solve the problems above, and an object thereof is to provide a method allowing suppression of growth of fungi adhering to food (in particular, meat) requiring storage by refrigeration, a method of thereby extending a durable life of food requiring storage by refrigeration, and an apparatus which can suitably be used for these methods.

### Solution to Problem

The present invention provides a method of storing meat stored in a refrigerator or a freezer after a lump of meat is prepared into small portions, including irradiating the meat with positive ions and negative ions before storage in the refrigerator or the freezer.

In the method of storing meat according to the present invention, preferably, the meat before preparation into small portions is irradiated with the positive ions and the negative ions.

In the method of storing meat according to the present invention, preferably, before storage in the refrigerator or the freezer, the meat prepared into small portions is irradiated with the positive ions and the negative ions.

In the present invention, preferably, the positive ions and the negative ions are emitted by blowing the positive ions and the negative ions generated through discharge in atmosphere.

The present invention also provides a method of extending a durable life of food requiring storage by refrigeration, by irradiating food requiring storage by refrigeration with positive ions and negative ions.

The present invention also provides a method of suppressing growth of fungi developed at a surface of food requiring storage by refrigeration, by irradiating food requiring storage by refrigeration with positive ions and negative ions before storage.

In the method according to the present invention, preferably, the food requiring storage by refrigeration is preferably at least any selected from the group consisting of meat, bread, boiled fish paste, tube-shaped fish paste, sausage, ham, bacon, noodles, cheese, and fish, and particularly preferably meat.

The present invention also provides an ion irradiation apparatus for suppressing growth of fungi, which includes an accommodation portion capable of accommodating food requiring storage by refrigeration and an ion generation portion emitting positive ions and negative ions into the inside of the accommodation portion, and growth of fungi developed at a surface of the food is suppressed by irradiating food requiring storage by refrigeration with the positive ions and the negative ions.

The present invention also provides an ion irradiation apparatus including an accommodation portion capable of accommodating food requiring storage by refrigeration and an ion generation portion emitting positive ions and negative ions into the inside of the accommodation portion, and a plurality of the ion generation portions are provided to surround the inside of the accommodation portion.

In the ion irradiation apparatus according to the present invention, two or more pairs of ion generation portions may be provided, with the pair of ion generation portions being opposed to each other, so as to surround the inside of the accommodation portion.

In the ion irradiation apparatus according to the present invention, the accommodation portion may be constructed such that a bottom surface can turn.

The ion irradiation apparatus according to the present invention has the accommodation portion implemented as a shelf-like article having a plurality of stages, and a plurality of ion generation portions may be provided for each section of the shelf-like article so as to surround the section. In this case, the ion irradiation apparatus according to the present invention includes blowing means or a resin sheet covering the entire accommodation portion. In this case, the ion irradiation apparatus according to the present invention may be constructed to be movable as a whole.

The ion irradiation apparatus according to the present invention has the accommodation portion implemented as a container-like article which can be transported with a plurality of container-like articles being stacked, and a plurality of ion generation portions may be provided to surround the inside of the container-like article. In this case, preferably, each container-like article is provided with a terminal for power supply, and when the container-like articles are stacked on an article like a wheeled platform which can electrically be connected to a power supply, each terminal is electrically connected and supplied with electricity from the power supply.

In the ion irradiation apparatus according to the present invention, the accommodation portion contains a transportation apparatus which can transport food requiring storage by refrigeration so as to pass through a plurality of regions, and one ion generation portion or a plurality of ion generation portions is/are provided for each region so as to irradiate the food with the positive ions and the negative ions while the food is transported. In this case, preferably, the food is irradiated with the positive ions and the negative ions in directions different from each other in each region. Furthermore, in this case, preferably, the accommodation portion has an examination region for detecting fungi adhering to a surface of food requiring storage by refrigeration, and is constructed such that the food is further irradiated with the positive ions and the negative ions when a result of examination in the examination region exceeds a predetermined reference value.

In the ion irradiation apparatus according to the present invention described above, preferably, the food requiring storage by refrigeration is preferably at least any selected from the group consisting of meat, bread, boiled fish paste, tube-shaped fish paste, sausage, ham, bacon, noodles, cheese, and fish, and particularly preferably meat.

### Advantageous Effects of Invention

According to the present invention, a method allowing suppression of growth of fungi adhering to food (in particular, meat) requiring storage by refrigeration, a method of thereby extending a durable life of food requiring storage by refrigeration, and an apparatus which can suitably be used for these methods can be provided.

### BRIEF DESCRIPTION OF DRAWINGS

FIG. 1 is a graph showing comparison between a case that positive ions and negative ions are emitted from one location and meat is placed and stored for a certain period of time at a position where the positive ions and the negative ions impinge (Example 1) and a case that positive ions and negative ions are not emitted (Comparative Example 1).

FIG. 2 is a graph showing comparison between a case that positive ions and negative ions are emitted from one location and meat is placed and stored for a certain period of time at a position where the positive ions and the negative ions are at a high concentration (Example 2) and a case that positive ions and negative ions are not emitted (Comparative Example 2).

FIG. 3 is a graph showing comparison between a case that positive ions and negative ions are emitted from six locations as surrounding from above, below, front, rear, left, and right and meat is placed and stored for a certain period of time at a position where the positive ions and the negative ions are at a high concentration (Example 3) and a case that positive ions and negative ions are not emitted (Comparative Example 3).

FIG. 4 is a diagram schematically showing an ion irradiation apparatus 1 representing one preferred example of the present invention.

FIG. 5 is a diagram schematically showing an ion irradiation apparatus 11 representing another preferred example of the present invention.

FIG. 6 is a diagram schematically showing an ion irradiation apparatus 21 representing another preferred example of the present invention.

FIG. 7 is a diagram schematically showing a state that a plurality of ion irradiation apparatuses 21 in the example shown in FIG. 6 are stacked.

FIG. 8 is (a) a diagram schematically showing an ion irradiation apparatus 31 in another preferred example of the present invention and (b) a diagram schematically showing an ion irradiation apparatus 41 in another preferred example of the present invention.

FIG. 9 is a diagram schematically showing an ion irradiation apparatus 51 employed in Example 1, with (a), (b), and (c) schematically showing an accommodation portion 52, an ion generation portion 54 attached to a lid portion 53 of accommodation portion 52, and irradiation of meat 55 accommodated in accommodation portion 52 with positive ions and negative ions from ion generation portion 54, respectively.

FIG. 10 is a diagram schematically showing a procedure in Example 1.

FIG. 11 is a diagram schematically showing an ion irradiation apparatus 61 employed in Example 2, with (a) showing a lid portion 63 and an ion generation portion 64 and (b) showing a state of attachment of lid portion 63 to an accommodation portion 62.

FIG. 12 is a diagram schematically showing an ion irradiation apparatus 71 employed in Example 3, with (a) showing lid portion 63 and ion generation portion 64 and (b) showing a state of attachment of lid portion 63 to accommodation portion 62.

### DESCRIPTION OF EMBODIMENTS

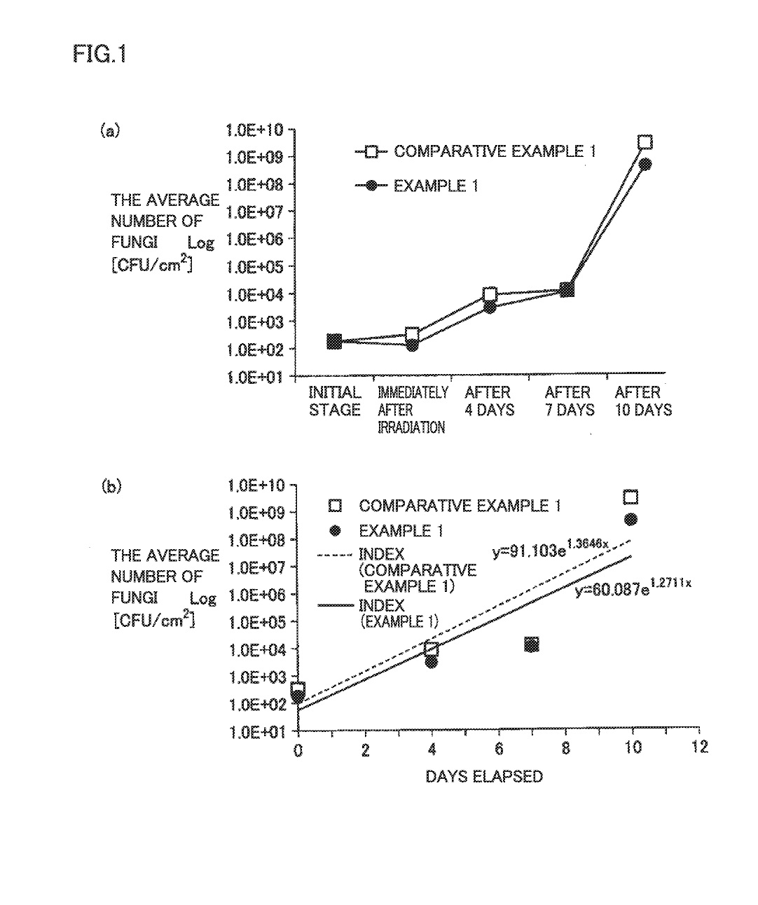

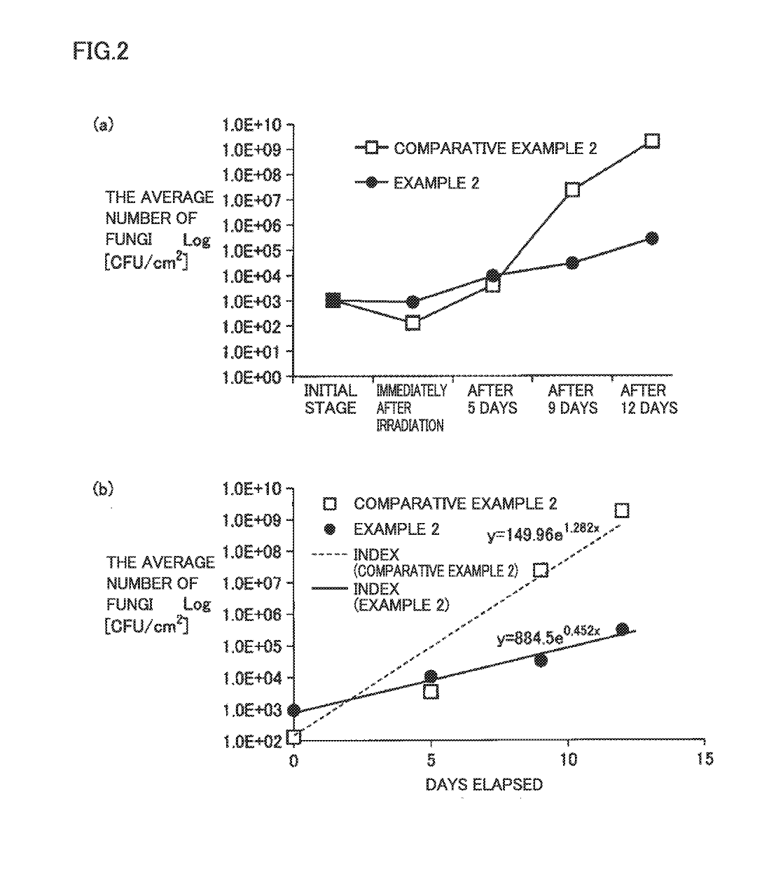

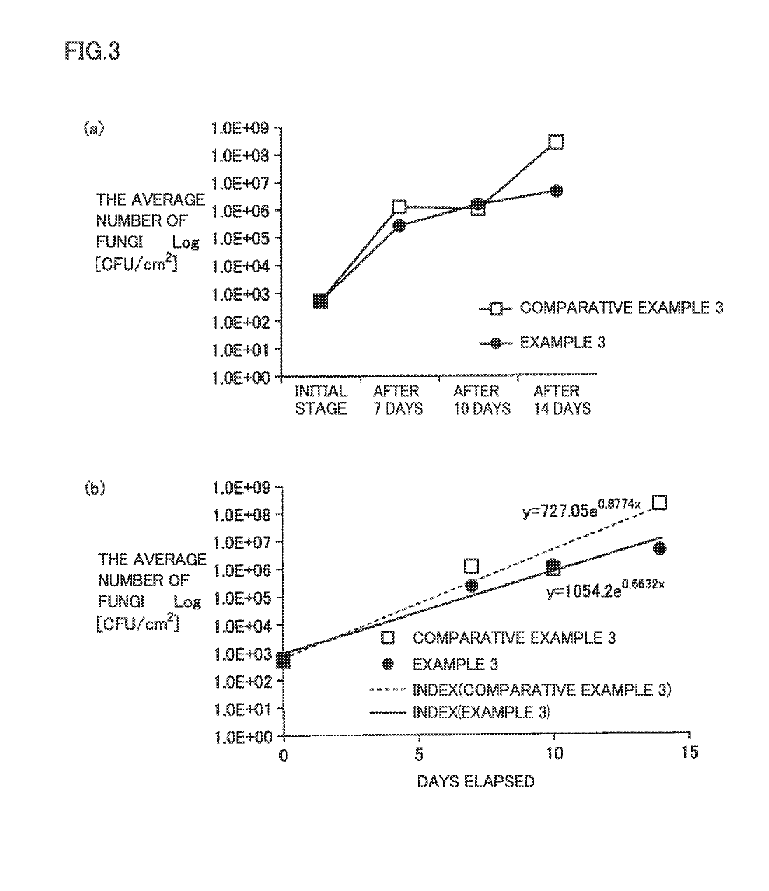

FIG. 1 is a graph showing comparison between a case that positive ions and negative ions are emitted from one location and meat is placed and stored for a certain period of time at a position where the positive ions and the negative ions impinge (Example 1: black circle) and a case that positive ions and negative ions are not emitted (Comparative Example 1: white square), with (a) showing a plot at each time point and (b) showing an index calculated from results in FIG. 1 (a). In FIG. 1, the ordinate represents an average number of fungi Log (CFU/cm²), the abscissa in FIG. 1 (a) represents each time point of an initial stage, immediately after irradiation, after 4 days, after 7 days, and after 10 days, and the abscissa in FIG. 1 (b) represents days which have elapsed. FIG. 2 is a graph showing comparison between a case that positive ions and negative ions are emitted from one location and meat is placed and stored for a certain period of time at a position where the positive ions and the negative ions are at a high concentration (Example 2: black circle) and a case that positive ions and negative ions are not emitted (Comparative Example 2: white square), with (a) showing a plot at each time point and (b) showing an index calculated from results in FIG. 2 (a). In FIG. 2, the ordinate represents an average number of fungi Log (CFU/cm²), the abscissa in FIG. 2 (a) represents each time point of an initial stage, immediately after irradiation, after 5 days, after 9 days, and after 12 days, and the abscissa in FIG. 2 (b) represents days which have elapsed. FIG. 3 is a graph showing comparison between a case that positive ions and negative ions are emitted from six locations as surrounding from above, below, front, rear, left, and right and meat is placed and stored for a certain period of time at a position where the positive ions and the negative ions are at a high concentration (Example 3: black circle) and a case that positive ions and negative ions are not emitted (Comparative Example 3: white square), with (a) showing a plot at each time point and (b) showing an index calculated from results in FIG. 3 (a). In FIG. 3, the ordinate represents an average number of fungi Log (CFU/cm²), the abscissa in FIG. 3 (a) represents each time point of an initial stage, after 7 days, after 10 days, and after 14 days, and the abscissa in FIG. 3 (b) represents days which have elapsed. As is clear from the results shown in FIGS. 1 to 3, when meat is irradiated with positive ions and negative ions, not much difference from a case without irradiation is observed in the initial stage, however, a difference in number of fungi is noticeable as days elapse. It can be concluded from these results that, by irradiating meat with positive ions and negative ions, growth of fungi adhering to the surface of meat is suppressed and the difference in number of fungi from a case without irradiation with positive ions and negative ions has become noticeable with lapse of days (representation in Log is provided on the ordinate in FIGS. 1 to 3 and a difference in digits indicates a significant difference).

The present invention is directed to a method of storing meat stored in a refrigerator or a freezer after a lump of meat is prepared into small portions, including irradiating the meat with positive ions and negative ions before storage in the refrigerator or the freezer. The method of storing meat according to the present invention is based on the results of experiments described above, and growth of fungi adhering to meat can be suppressed by irradiating the meat with positive ions and negative ions before storage in a refrigerator or a freezer. Thus, a durable life of meat for which the number of adhering fungi serves as an indicator can be extended.

To stores which sell meat prepared in small portions as being packaged such as meat shops and supermarkets, for example, meat in a lump in a plastic bag is delivered from wholesalers by trucks and the meat is once stored at a temperature around 0° C. as being accommodated in a container-like article with the meat remaining in the plastic bag. Thereafter, the stored meat in a lump is taken out of the plastic bag, transported to a meat processing site in the store, and processed into small portions manually or by a machine operation at the meat processing site. Preparation into small portions here includes also mincing meat. A temperature at a food processing site is normally approximately from 10 to 15° C. for workers to be engaged in processing. Meat prepared in small portions is packaged for each appropriate amount, stored in a refrigerator or a freezer as being accommodated in a container-like article, and sold at the stores as appropriate.

In the method of storing meat according to the present invention, meat should only be irradiated with positive ions and negative ions at a time point before storage in a refrigerator or a freezer. The timing of irradiation may be in a state before preparation into small portions (a state in a lump) or in a state of being prepared into small portions. In view of the fact that fungi often adhere during the process for preparation into small portions as described above, meat prepared into small portions is preferably irradiated with positive ions and negative ions. Naturally, meat may be irradiated with positive ions and negative ions at timing of both of the state before preparation into small portions and a state of being prepared into small portions.

Positive ions and negative ions in the present invention are preferably emitted by blowing positive ions and negative ions generated through discharge in atmosphere. More specifically, molecules of oxygen (O₂) and water (H₂O) in air receive energy through a discharge phenomenon of ion generation elements, so that positive ions composed of H⁺(H₂O)ₘ (m being any integer) and negative ions composed of O₂⁻(H₂O)ₙ (n being any integer) are generated and blown toward meat and the meat is irradiated with the positive ions and the negative ions. Normally, by alternately applying positive and negative voltages to ion generation elements, positive ions and negative ions can simultaneously be generated and emitted into air. The method of generating positive ions and negative ions employed in the present invention, however, is not limited thereto. Only any one voltage of a positive voltage and a negative voltage can be applied to firstly generate only one of positive ions and negative ions, and thereafter a reverse voltage is applied to generate ions having charges opposite to the ions which have already been emitted. Though a known ion generation apparatus which has been proposed by the applicant, for example, in Japanese Patent No. 3680121 can be applied as such means for generating positive ions and negative ions without being particularly restricted, an ion irradiation apparatus according to the present invention which will be described later is particularly preferably employed.

With regard to composition of positive ions and negative ions generated through the discharge phenomenon with oxygen molecules and/or water molecules present on a surface of a discharge element serving as source materials, mainly as positive ions, water molecules in air are electrolytically dissociated through plasma discharge to generate hydrogen ions H±, which cluster together with water molecules in air owing to solvation energy to thereby form H⁺(H₂O)ₘ (m being any integer). Meanwhile, with regard to negative ions, oxygen molecules or water molecules in air are electrolytically dissociated through plasma discharge to generate oxygen ions O₂⁻, which cluster together with water molecules in air owing to solvation energy to thereby form O₂⁻(H₂O)ₙ (n being any integer). In addition, as a result of reaction between both of them, more active species such as hydrogen peroxide H₂O₂, hydrogen dioxide O₂H, or hydroxyl radicals .OH can readily be generated.

In the present invention, from a point of view of noticeable ability to obtain an effect of suppression of growth of fungi, a concentration of positive ions and negative ions generated through discharge is preferably not less than 500,000/cm³. The number of ions is defined based on count of small ions and critical mobility in air of 1 cm²/V·second.

Whether or not air contains such positive ions and negative ions can be determined by examining a gas composition through gas mass spectrometry, a gas concentration test, a color change test, an odor test, a light emission test, or a generated sound test. A known mass spectrometer can be made use of for gas mass spectrometry, and gas chromatography or an ion counter can be used for measurement in a gas concentration test. A color change test or an odor test can be conducted as a sensory test such as visual observation or olfactometry, and a color difference meter or an odor sensor can also be made use of. A light emission test or a generated sound test can also be conducted as a sensory test such as visual observation or an aural test, and an absorptiometer, a spectroscope, an optical sensor, an illuminometer, or a microphone can be made use of.

Though a time period of irradiation with positive ions and negative ions is not particularly restricted in the method of storing meat according to the present invention, it is preferably not shorter than 1.5 hours when a concentration of positive ions and negative ions is set to 500,000/cm³.

The present invention also provides a method of extending a durable life of food requiring storage by refrigeration, by irradiating food requiring storage by refrigeration with positive ions and negative ions before storage by refrigeration. The durable life is defined as a date indicating a due date until which there is no possibility of lack of safety with perishing, deterioration, or other degradation in quality in storage with a determined method, and it is indicated for food of which quality rapidly degrades within approximately 5 days including a date of production (corresponding to food requiring storage by refrigeration as defined in the present invention). The durable life is set in consideration of such elements as characteristics of food, a factor for change in quality or a sanitary state of a raw material, a state of sanitary control during production and processing, and a state of storage. For food, description, for example, in Hisao Yoshii et al., “Shokuhin Biseibutsugaku Handbook” (1995) can be referenced. According to the present invention, by irradiating food requiring storage by refrigeration with positive ions and negative ions before storage by refrigeration, growth of fungi adhering to a surface of the food can be suppressed and the time until the number of fungi bringing about perishing of food is reached can be retarded, and consequently the durable life of food can be extended.

Furthermore, the present invention also provides a method of suppressing growth of fungi developed at a surface of food requiring storage by refrigeration, by irradiating food requiring storage by refrigeration with positive ions and negative ions before storage by refrigeration.

In the method of extending a durable life of food requiring storage by refrigeration and the method of suppressing growth of fungi developed at a surface of food requiring storage by refrigeration according to the present invention, food is not limited to meat so long as the food requires storage by refrigeration, and examples thereof include bread, boiled fish paste, tube-shaped fish paste, sausage, ham, bacon, noodles, cheese, and fish. Among these, meat for which it is assumed that fungi adhere to the surface of meat particularly when meat in a lump is manually or mechanically processed into small portions at a meat processing site is preferred as described above.

Positive ions and negative ions used in the method of extending a durable life of food requiring storage by refrigeration and the method of suppressing growth of fungi developed at a surface of food requiring storage by refrigeration according to the present invention, a concentration thereof, and a time period of irradiation therewith are the same as described above for the method of storing meat according to the present invention.

The present invention also provides an ion irradiation apparatus (a first embodiment) for suppressing growth of fungi, which includes an accommodation portion capable of accommodating food requiring storage by refrigeration and an ion generation portion emitting positive ions and negative ions into the inside of the accommodation portion, growth of fungi developed at a surface of the food being suppressed by irradiating food requiring storage by refrigeration with the positive ions and the negative ions. According to such an ion irradiation apparatus for suppressing growth of fungi according to the present invention, the methods according to the present invention described above (the method of storing meat, the method of extending a durable life of food requiring storage by refrigeration, and the method of suppressing growth of fungi developed at a surface of food requiring storage by refrigeration) can particularly suitably be employed. A construction of an accommodation portion and an ion generation apparatus is not particularly restricted so long as the ion irradiation apparatus for suppressing growth of fungi according to the present invention is applied to such an application as suppression of growth of fungi developed at a surface of food requiring storage by refrigeration. The ion irradiation apparatus for suppressing growth of fungi should only be implemented by appropriately combining conventionally known features, and is preferably constructed to emit positive ions and negative ions generated through discharge by blowing the positive ions and the negative ions.

The present invention also provides an ion irradiation apparatus (a second embodiment) which includes an accommodation portion capable of accommodating food requiring storage by refrigeration and an ion generation portion emitting positive ions and negative ions into the inside of the accommodation portion, a plurality of the ion generation portions being provided to surround the inside of the accommodation portion. By providing a plurality of ion generation portions so as to surround the inside of the accommodation portion as in the ion irradiation apparatus in the second embodiment, the surface of food requiring storage by refrigeration can be irradiated with positive ions and negative ions in two or more directions when the food is accommodated in the accommodation portion. For example, in a case of meat, fungi adhere to the surface of meat and substantially no fungi are included in the inside of meat when the meat is processed into small portions. Therefore, by irradiating the surface of food with positive ions and negative ions in two or more directions as in the ion irradiation apparatus in the second embodiment, growth of fungi adhering to the surface of the food can effectively be suppressed.

Here, two or more pairs of the ion generation portions are provided, with the pair of ion generation portions being opposed to each other, so as to surround the inside of the accommodation portion (a third embodiment). Namely, two or more directions of irradiation with ions are present, and two or more pairs of ion generation portions are provided such that directions of irradiation intersect with each other. By accommodating food requiring storage by refrigeration in a region in the accommodation portion where the directions of irradiation intersect with each other, the two or more paired surfaces of the food can be irradiated with positive ions and negative ions and an effect of suppression of growth of fungi adhering to the surface of the food described above can be more noticeable.

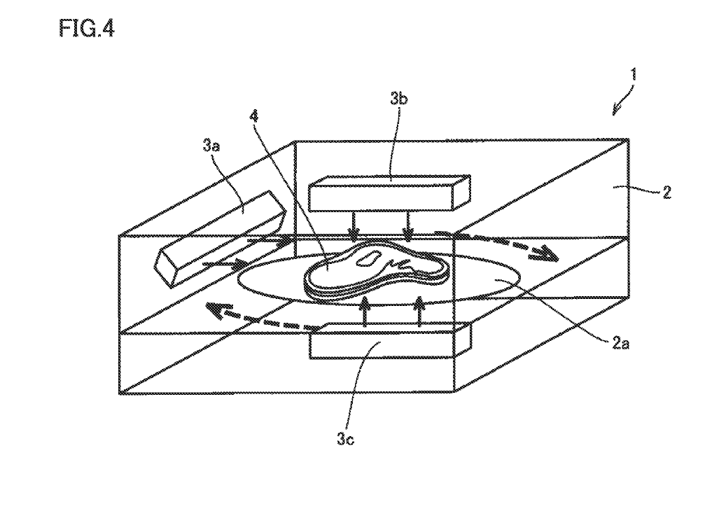

Here, FIG. 4 is a diagram schematically showing an ion irradiation apparatus 1 representing one preferred example of the present invention. Ion irradiation apparatus 1 in the example shown in FIG. 4 is provided with three ion generation portions 3a, 3b, and 3c so as to surround the inside of an accommodation portion 2, and corresponds to the ion irradiation apparatus in the second embodiment described above. In ion irradiation apparatus 1 in the example shown in FIG. 4, accommodation portion 2 is constructed as a turntable such that a bottom surface 2a thereof can turn (a fourth embodiment). Thus, while food (meat in the example in FIG. 4) 4 requiring storage by refrigeration is placed on bottom surface 2a of accommodation portion 2, the food can be irradiated with positive ions and negative ions by three ion generation portions 3a, 3b, and 3c with the food being turned around a central axis of bottom surface 2a and the surface of the food is evenly irradiated with positive ions and negative ions, so that growth of fungi adhering to the surface of the food described above can effectively be suppressed.

In the case of the fourth embodiment, a dish shaped article or a container-like article for placing food may be provided on bottom surface 2a of accommodation portion 2 and the dish shaped article or the container-like article may be turned on bottom surface 2a. In this case, the dish shaped article or the container-like article may have a structure allowing passage of a certain amount of air including positive ions and negative ions (like a web or grids).

The number of ion generation portions in the fourth embodiment is not particularly limited. For example, as in the example shown in FIG. 4, the ion generation portions are preferably placed in at least three directions on a bottom surface side, a top surface side, and a side surface side. When the ion generation portion is placed on the bottom surface side, the bottom surface of the rotatable accommodation portion preferably has a structure allowing passage of a certain amount of air including positive ions and negative ions as described above.

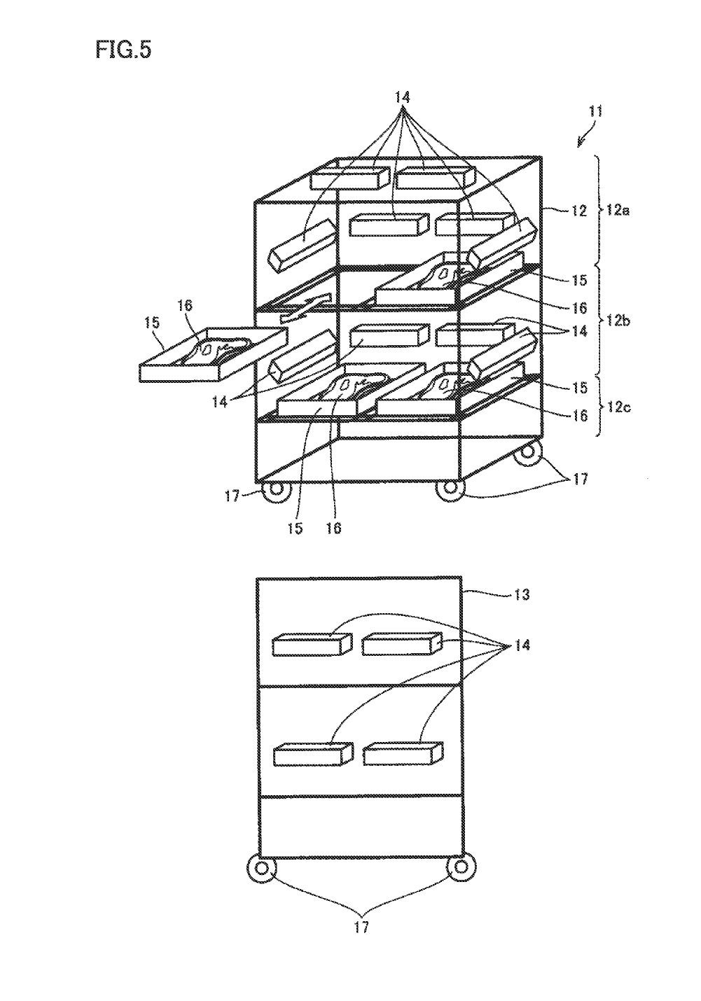

FIG. 5 is a diagram schematically showing an ion irradiation apparatus 11 representing another preferred example of the present invention. In ion irradiation apparatus 11 in the example shown in FIG. 5, an accommodation portion 12 is a shelf-like article partitioned into a plurality of stages (three stages in the example in FIG. 5), and a plurality of ion generation portions 14 (for example, 1 to 14 on five surfaces of upper, front, rear, left, and right surfaces) are provided to surround sections 12a, 12b, and 12c in the shelf-like article for each section (in the example in FIG. 5, sections 12a, 12b, and 12c) (a fifth embodiment). In the fifth embodiment, as in the example shown in FIG. 5, preferably, a door 13 of the shelf-like article also includes a plurality of ion generation portions 14 in correspondence with the sections in the shelf-like article, and is constructed to be able to emit positive ions and negative ions also from a door side while door 13 is closed. In the example shown in FIG. 5, each section stores food (meat in the example in FIG. 5) 16 requiring storage by refrigeration while the food is placed on a tray-like article 15. The tray-like article may be a container-like article. Thus, by irradiating food 16 with positive ions and negative ions in a plurality of directions by using ion generation portions 14 surrounding each section, growth of fungi adhering to the surface of a plurality of pieces of food requiring storage by refrigeration can simultaneously be suppressed.

In the fifth embodiment, the ion irradiation apparatus may include blowing means (not shown). When the blowing means is further provided, such an effect that positive ions and negative ions can be emitted into the entire shelf-like article. When drying of the surface of food requiring storage by refrigeration is not preferred (for example, meat prepared into small portions), no blowing means is desirably provided in order to avoid drying of the surface of food by blowing. In the case of food of which surface is preferably not dried, the ion irradiation apparatus may include a resin sheet (not shown) covering the entire accommodation portion in order to suppress drying of the food.

In the fifth embodiment, the ion irradiation apparatus may be constructed to be movable as a whole. Though FIG. 5 shows an example in which the entire apparatus can be moved as four casters 17 are attached under accommodation portion 12 implemented as the shelf-like article and two casters 17 are attached also to door 13, limitation thereto is naturally not intended.

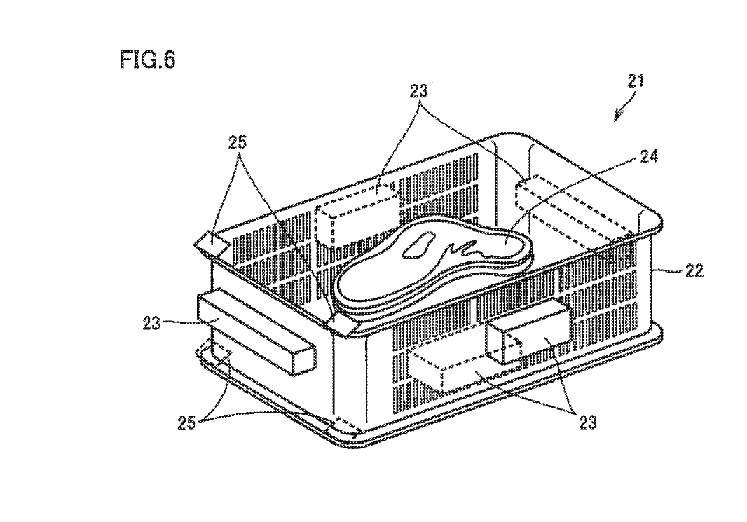

FIG. 6 is a diagram schematically showing an ion irradiation apparatus 21 representing another preferred example of the present invention. In ion irradiation apparatus 21 in the example shown in FIG. 6, an accommodation portion 22 is implemented as a container-like article which can be transported with a plurality of container-like articles being stacked, and a plurality of ion generation portions 23 are provided to surround the container-like inside (a sixth embodiment). In the sixth embodiment, as in the example shown in FIG. 6, accommodation portion 22 implemented as a container-like article is provided and a plurality of ion generation portions 23 (in the example shown in FIG. 6, 5 ion generation apparatuses in the front and the rear, on the left and right, and below) are provided to surround the inside of accommodation portion 22. Food (in the example shown in FIG. 6, meat) 24 requiring storage by refrigeration is placed in a space surrounded by the plurality of ion generation portions 23.

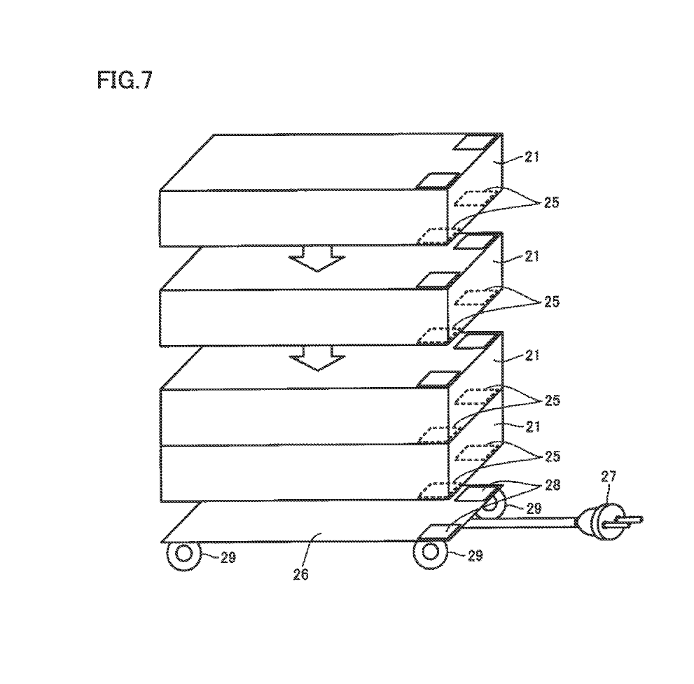

FIG. 7 is a diagram schematically showing a state that a plurality of ion irradiation apparatuses 21 in the example shown in FIG. 6 are stacked. Ion irradiation apparatus 21 in the sixth embodiment is provided with a terminal 25 for power supply, and preferably constructed such that when container-like articles are stacked on an article like a wheeled platform 26 which can electrically be connected to the power supply, each terminal 25 is electrically connected and electricity can be supplied from the power supply. In FIGS. 6 and 7, terminal 25 is provided at an end portion of each of upper and lower surfaces of the container-like article and terminals 25 of container-like articles adjacent to each other are in contact with each other when the plurality of container-like articles are stacked. Article like wheeled platform 26 includes an electric cord 27 which can electrically be connected to the power supply, a terminal 28 on a side of the article like wheeled platform is provided at an end portion of a placement surface 26a for placing the container-like article. When the container-like article is placed, terminal 25 on the side of the lower surface of the lowermost container-like article is in contact with terminal 28 on the side of the article like wheeled platform and electrical connection with the power supply can be established through terminal 28 on the side of the article like wheeled platform, so that electricity is supplied to each container-like article and ion generation portion 23 provided in each container-like article is driven. Thus, it is not necessary to provide a special power supply for each container-like article and efficient loading even into a relatively narrow place can be achieved with a minimal necessary space.

In the example shown in FIG. 7, casters 29 are attached to a lower side of article like wheeled platform 26 and article like wheeled platform 26 is constructed to be movable with one container-like article or a plurality of container-like articles being placed thereon.

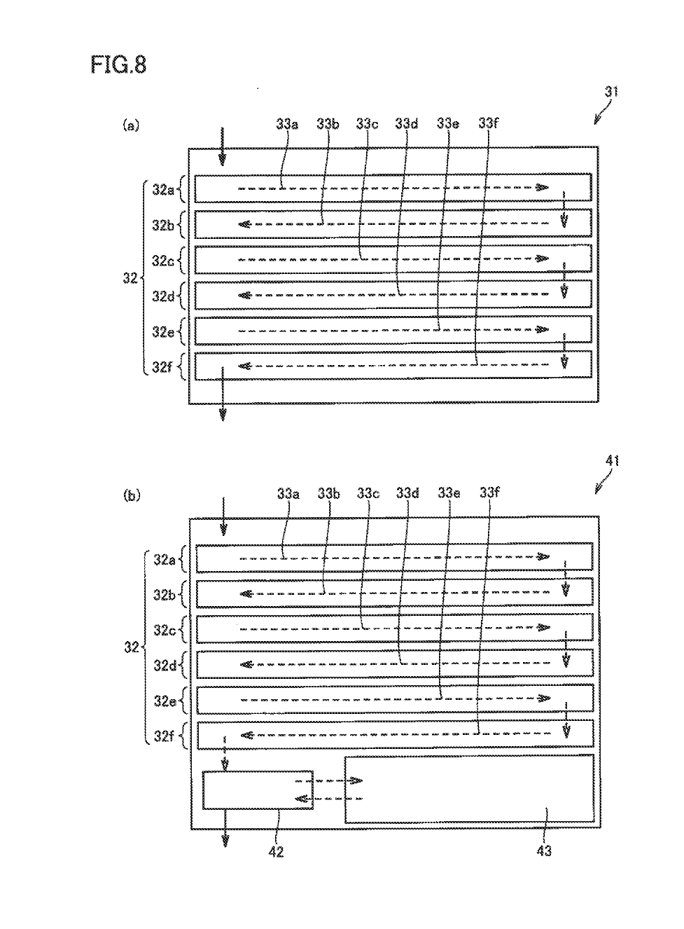

FIG. 8 (a) is a diagram schematically showing an ion irradiation apparatus 31 in another preferred example of the present invention. Ion irradiation apparatus 31 is constructed such that the accommodation portion contains a transportation apparatus which can transport food requiring storage by refrigeration so as to pass through a plurality of regions, and one ion generation portion or a plurality of ion generation portions is/are provided for each region so as to irradiate the food with positive ions and negative ions while the food is transported (a seventh embodiment). In the example shown in FIG. 8 (a), six elongated regions 32a, 32b, 32c, 32d, 32e, and 32f are set as being aligned such that longitudinal directions thereof are in parallel to one another, regions 32a, 32b, 32c, 32d, 32e, and 32f are provided with transportation apparatuses (for example, belt conveyors) 33a, 33b, 33c, 33d, 33d, and 33f, respectively, and transportation apparatuses adjacent to each other are set to be opposite in direction of transportation. In the example shown in FIG. 8 (a), all of regions 32a, 32b, 32c, 32d, 32e, and 32f correspond to an accommodation portion 32 of ion irradiation apparatus 31. For example, when food (not shown) is loaded at an end portion on the left of a transportation apparatus 33a from above the sheet surface of FIG. 8 (a), the food is transported from the left toward the right as shown with an arrow in Fig. (a) and when the food reaches the right end, it is transferred to an adjacent transportation apparatus 33b. Transportation apparatus 33b transports the food (not shown) from the right toward the left and thereafter transfers the food to an adjacent transportation apparatus 33c. After transportation by a plurality of transportation apparatuses as above, food is unloaded. During this transportation, food is irradiated with positive ions and negative ions from one ion generation portion or a plurality of ion generation portions (not shown) placed for each region.

Ion irradiation apparatus 31 in the seventh embodiment is preferably constructed such that food is irradiated with positive ions and negative ions in directions different from one another in each region. For example, in the example shown in FIG. 8 (a), an upper surface is irradiated in transportation apparatus 33a, a lower surface is irradiated in transportation apparatus 33b, and side surfaces (any of four surfaces of front, rear, left, and right surfaces) are irradiated in transportation apparatuses 33c, 33d, 33e, and 33f, respectively. By doing so, food can be irradiated with positive ions and negative ions in various directions, so that growth of fungi at each surface of the food can be suppressed, the time until the number of fungi bringing about perishing of food is reached can be retarded, and a durable life of food can consequently be extended.

FIG. 8 (b) is a diagram schematically showing an ion irradiation apparatus 41 in another preferred example of the present invention. Ion irradiation apparatus 41 in the example shown in FIG. 8 (b) is constructed such that the accommodation portion has an examination region 42 for detecting fungi adhering to the surface of food requiring storage by refrigeration in addition to the features the same as in ion irradiation apparatus 31 shown in FIG. 8 (a), and when a result of examination in examination region 42 exceeds a predetermined reference value, food is further irradiated with positive ions and negative ions (an eighth embodiment). In the example shown in FIG. 8 (b), fungi adhering to the surface of food (not shown) transported successively from transportation apparatus 33a to transportation apparatus 33f are detected in examination region 42, and when a result of examination does not exceed a predetermined reference value, the food is unloaded as it is as in the example shown in FIG. 8 (a). On the other hand, when the result of examination exceeds the predetermined reference value, food is moved to a preparatory irradiation area 43 and irradiated with positive ions and negative ions. Thereafter, food is returned to examination region 42 and unloaded. After food is returned to examination region 42, further examination may be conducted and further irradiation with positive ions and negative ions may be repeated in preparatory irradiation area 43 until a result of examination does not exceed the predetermined reference value. A known examination method can be applied to examination conducted in examination region 42 for detecting fungi adhering to the surface of food without being particularly restricted, and for example, an examination can be conducted in Examples in a procedure which will be described later.

In the ion irradiation apparatus according to the present invention in each embodiment as described above as well, food requiring storage by refrigeration is not limited to meat as described in connection with the method according to the present invention described above, and examples include bread, boiled fish paste, tube-shaped fish paste, sausage, ham, bacon, noodles, cheese, and fish. Among these, meat for which it is assumed that fungi adhere to the surface of meat particularly when meat in a lump is manually or mechanically processed into small portions at a meat processing site is preferred as described above.

Though the present invention will be described below in further detail with reference to Examples, the present invention is not limited thereto.

### Example 1

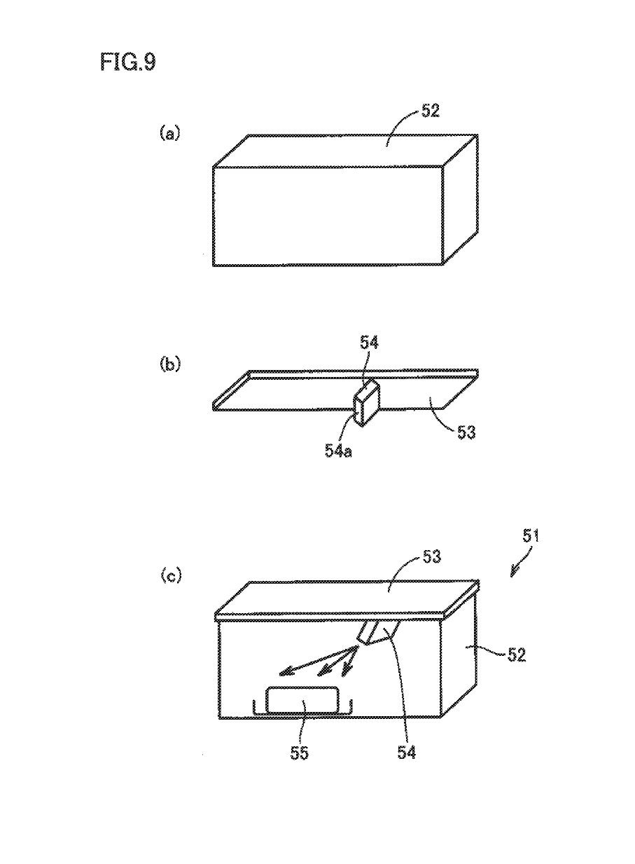

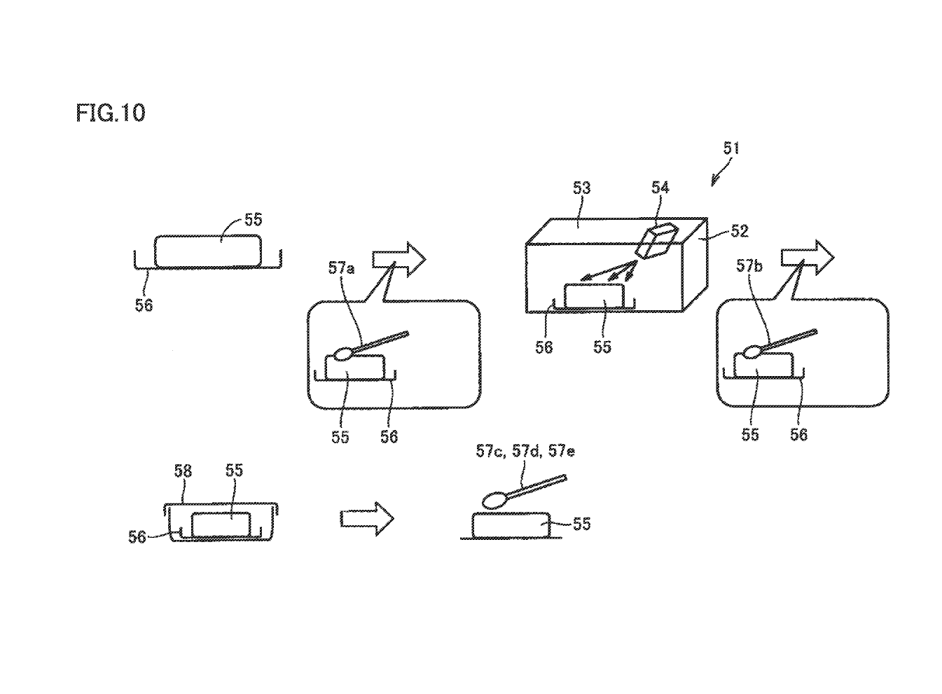

FIG. 9 is a diagram schematically showing an ion irradiation apparatus 51 employed in Example 1, with (a), (b), and (c) schematically showing an accommodation portion 52, an ion generation portion 54 attached to a lid portion 53 of accommodation portion 52, and irradiation of meat 55 accommodated in accommodation portion 52 with positive ions and negative ions from ion generation portion 54, respectively. FIG. 10 is a diagram schematically showing a procedure in Example 1. In Example 1, initially, as shown in FIG. 10, meat 55 (specifically, approximately 300 g of beef flank block) was placed on a petri dish 56, fungi adhering to the surface of meat 55 were wiped off by a fungi collection rod (cotton swab) 57a, and fungi adhering to the fungi collection rod were diluted with sterilized water and applied to standard agar. Fungi were thus taken (a wiping method). Thereafter, meat 55 was accommodated in accommodation portion 52 of ion irradiation apparatus 51 shown in FIG. 9 (c) and irradiated with positive ions and negative ions. In ion irradiation apparatus 51 employed in Example 1, accommodation portion 52 had a size of approximately 12 L (23.5 cm wide×34.5 cm deep×15.0 cm high), ion generation portion 54 was arranged in an internal space of accommodation portion 52 with lid portion 53 being attached to accommodation portion 52, and positive ions and negative ions were emitted from diagonally above meat 55. Ion generation portion 54 had an ion outlet 54a having a size of 7.5 cm×2.0 cm and had a depth of 5.7 cm. A concentration of ions was set to 500,000/cm³ in total of positive ions and negative ions, and a time period of irradiation was set to 90 minutes. A temperature of the internal space of accommodation portion 52 during ion irradiation was controlled to approximately 0° C. by using a low-temperature incubator (FMU-203I manufactured by Fukushima Industries, Corp.) and a humidity was not controlled.

After irradiation with positive ions and negative ions for 90 minutes, meat 55 in petri dish 56 was taken out of accommodation portion 52 and fungi at the surface of meat 55 immediately after ion irradiation were taken with a fungi collection rod 57b. Thereafter, meat 55 in petri dish 56 was accommodated in an airtight container 58, stored in a household refrigerator (an average temperature: approximately 3.5° C.), fungi were taken at time points of 4 days, 7 days, and 10 days after ion irradiation, by using fungi collection rods 57c, 57d, and 57e, respectively, and change over time in number of fungi was observed.

### Comparative Example 1

Change over time in number of fungi was observed as in Example 1 except for absence of ion irradiation.

FIG. 1 is a graph showing comparison between a case that positive ions and negative ions were emitted from one location and meat was placed and stored for a certain period of time at a position where the positive ions and the negative ions impinged (Example 1) and a case that positive ions and negative ions were not emitted (Comparative Example 1). In FIG. 1, the ordinate represents an average number of fungi Log (CFU/cm²), the abscissa in FIG. 1 (a) represents each time point of an initial stage, immediately after irradiation, after 4 days, after 7 days, and after 10 days, and the abscissa in FIG. 1 (b) represents days which elapsed.

Table 1 shows an average number of fungi (CFU/cm²) at each time point in Example 1 and Comparative Example 1 and Table 2 shows an expected value for the number of fungi (CFU/cm²) calculated from an approximation line shown in FIG. 1 (b).

TABLE 1

| | | | Immediately | | | |
|---|---|---|---|---|---|---|
| | | Initial | After | After | After | After |
| | | Stage | Irradiation | 4 Days | 7 Days | 10 Days |
| The Average | Example 1 | 1.9E+02 | 1.3E+02 | 2.9E+03 | 1.1E+04 | 4.3E+08 |
| Number of | Comparative | 1.9E+02 | 3.3E+02 | 8.8E+03 | 1.3E+04 | 2.8E+09 |
| Fungi | Example 1 | | | | | |
| (CFU/cm²) | | | | | | |

TABLE 2

| Days Elapsed | Example 1 | Comparative Example 1 |
|---|---|---|
| 0 | 6.0E+01 | 9.1E+01 |
| 1 | 2.1E+02 | 3.6E+02 |
| 2 | 7.6E+02 | 1.4E+03 |
| 3 | 2.7E+03 | 5.5E+03 |
| 4 | 9.7E+03 | 2.1E+04 |
| 5 | 3.5E+04 | 8.4E+04 |
| 6 | 1.2E+05 | 3.3E+05 |
| 7 | 4.4E+05 | 1.3E+06 |
| 8 | 1.6E+06 | 5.0E+06 |
| 9 | 5.6E+06 | 2.0E+07 |
| 10 | 2.0E+07 | 7.7E+07 |
| 11 | 7.1E+07 | 3.0E+08 |
| 12 | 2.5E+08 | 1.2E+09 |

As a result of ion irradiation, 10 days after storage in a refrigerator, the number of fungi decreased by 84.5% in Example 1. Based on the expected value for the number of fungi, in Example 1, days until a value not less than 10⁶ CFU/cm² at which smell changes is reached, a value not less than 10⁷ to 10⁸ CFU/cm² at which a viscous product is formed is reached, and a value not less than 10⁸ CFU/cm² at which ammonia is generated is reached (reference: Hisao Yoshii et al., “Shokuhin Biseibutsugaku Handbook” (1995)) extended by one day. As is clear also from the results shown in FIG. 1, when meat was irradiated with positive ions and negative ions, not much difference from a case without irradiation was observed in the initial stage, however, a difference in average number of fungi was noticeable as days elapsed. It can be concluded from these results that, by irradiating meat with positive ions and negative ions, growth of fungi adhering to the surface of meat was suppressed and the difference in number of fungi from a case without irradiation with positive ions and negative ions became noticeable with lapse of days (representation in Log is provided on the ordinate in FIG. 1 and difference in digits indicates a significant difference).

### Example 2

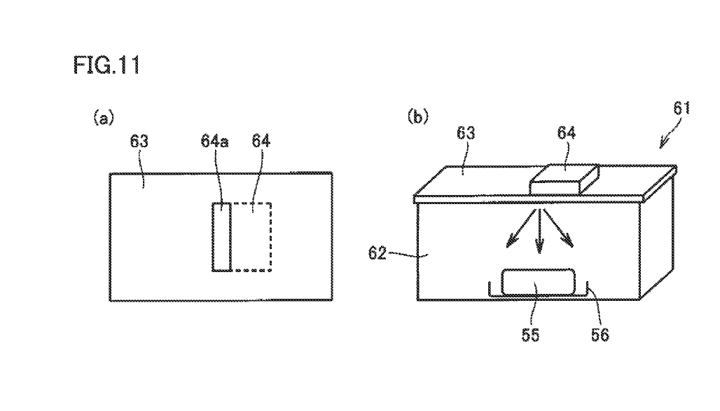

FIG. 11 is a diagram schematically showing an ion irradiation apparatus 61 employed in Example 2, with (a) showing a lid portion 63 and an ion generation portion 64 and (b) showing a state of attachment of lid portion 63 to an accommodation portion 62. In ion irradiation apparatus 61 employed in Example 2, ion generation portion 64 is attached around the center outside lid portion 63. Ion generation portion 64 had a size of 7.0 cm×7.5 cm×2.0 cm, and an ion outlet 64a had a size of 7.5 cm×2.0 cm. In Example 2, ion generation portion 63 was arranged outside accommodation portion 62, such that meat 55 accommodated in accommodation portion 62 was irradiated with positive ions and negative ions from directly above. With the use of such ion irradiation apparatus 61, change over time in number of fungi was observed as in Example 1 except that fungi were taken at time points of 5 days, 9 days, and 12 days after ion irradiation.

### Comparative Example 2

Change over time in number of fungi was observed as in Example 2 except for absence of ion irradiation.

FIG. 2 is a graph showing comparison between a case that positive ions and negative ions were emitted from one location and meat was placed and stored for a certain period of time at a position where the positive ions and the negative ions were at a high concentration (Example 2: black circle) and a case that positive ions and negative ions were not emitted (Comparative Example 2: white square), with (a) showing a plot at each time point and (b) showing an index calculated from results in FIG. 2 (a). In FIG. 2, the ordinate represents an average number of fungi Log (CFU/cm²), the abscissa in FIG. 2 (a) represents each time point of an initial stage, immediately after irradiation, after 5 days, after 9 days, and after 12 days, and the abscissa in FIG. 2 (b) represents days which elapsed.

Table 3 shows an average number of fungi (CFU/cm²) at each time point in Example 2 and Comparative Example 2 and Table 4 shows an expected value for the number of fungi (CFU/cm²) calculated from an approximation line shown in FIG. 2 (b).

TABLE 3

| | | | Immediately | | | |
|---|---|---|---|---|---|---|
| | | Initial | After | After | After | After |
| | | Stage | Irradiation | 5 Days | 9 Days | 12 Days |
| The Average | Example 2 | 1.1E+03 | 8.1E+02 | 9.2E+03 | 3.1E+04 | 2.8E+05 |
| Number of | Comparative | 1.1E+03 | 1.3E+02 | 3.7E+03 | 2.4E+07 | 2.0E+09 |
| Fungi | Example 2 | | | | | |
| (CFU/cm²) | | | | | | |

TABLE 4

| Days Elapsed | Example 2 | Comparative Example 2 |
|---|---|---|
| 0 | 8.8E+02 | 1.5E+02 |
| 1 | 1.4E+03 | 5.4E+02 |
| 2 | 2.2E+03 | 1.9E+03 |
| 3 | 3.4E+03 | 7.0E+03 |
| 4 | 5.4E+03 | 2.5E+04 |
| 5 | 8.5E+03 | 9.1E+04 |
| 6 | 1.3E+04 | 3.3E+05 |
| 7 | 2.1E+04 | 1.2E+06 |
| 8 | 3.3E+04 | 4.3E+06 |
| 9 | 5.2E+04 | 1.5E+07 |
| 10 | 8.1E+04 | 5.5E+07 |
| 11 | 1.3E+05 | 2.0E+08 |
| 12 | 2.0E+05 | 7.2E+08 |
| 13 | 3.2E+05 | 2.6E+09 |
| 14 | 5.0E+05 | 9.3E+09 |
| 15 | 7.8E+05 | 3.4E+10 |
| 16 | 1.2E+06 | 1.2E+11 |
| 17 | 1.9E+06 | 4.4E+11 |
| 18 | 3.0E+06 | 1.6E+12 |
| 19 | 4.7E+06 | 5.7E+12 |
| 20 | 7.5E+06 | 2.0E+13 |
| 21 | 1.2E+07 | 7.4E+13 |
| 22 | 1.8E+07 | 2.7E+14 |
| 23 | 2.9E+07 | 9.6E+14 |
| 24 | 4.5E+07 | 3.5E+15 |
| 25 | 7.1E+07 | 1.2E+16 |
| 26 | 1.1E+08 | 4.5E+16 |

As a result of ion irradiation, 9 days after storage in a refrigerator, the number of fungi decreased by 99.9% in Example 2. Based on the expected value for the number of fungi, extension to 9 days until a value not less than 10⁶ CFU/cm² at which smell changes is reached, extension to 12 days until a value not less than 10⁷ to 10⁸ CFU/cm² at which a viscous product is formed is reached, and extension to 15 days until a value not less than 10⁸ CFU/cm² at which ammonia is generated is reached were achieved. As is clear also from the results shown in FIG. 2, when meat was irradiated with positive ions and negative ions, not much difference from a case without irradiation was observed in the initial stage, however, a difference in average number of fungi was noticeable as days elapsed. It can be concluded from these results that, by irradiating meat with positive ions and negative ions, growth of fungi adhering to the surface of meat was suppressed and the difference in number of fungi from a case without irradiation with positive ions and negative ions became noticeable with lapse of days (representation in Log is provided on the ordinate in FIG. 2 and difference in digits indicates a significant difference).

### Example 3

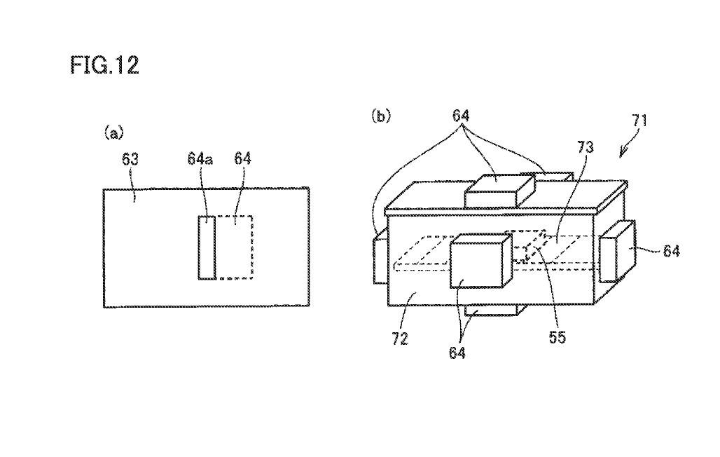

FIG. 12 is a diagram schematically showing an ion irradiation apparatus 71 employed in Example 3, with (a) showing lid portion 63 and ion generation portion 64 and (b) showing a state of attachment of lid portion 63 to accommodation portion 72. Though ion irradiation apparatus 71 shown in FIG. 12 includes ion generation portion 64 the same as shown in FIG. 11, it is different in that not only ion generation portion 64 is attached outside lid portion 63 so as to emit positive ions and negative ions from above, but also similar ion generation portion 64 is provided also on front, rear, left, right and lower sides around an accommodation portion 72 so as to emit positive ions and negative ions into the internal space of accommodation portion 72. When ion irradiation apparatus 71 shown in FIG. 12 (b) is employed, meat 55 is placed on a web-like article or a grid-like article 73 such that it can be irradiated with positive ions and negative ions efficiently also from below. Ion irradiation apparatus 71 employed in Example 3 had accommodation portion 72 having a size of approximately 17 L (27.6 cm wide×38.3 cm deep×24.6 cm high), and approximately 150 g of beef flank block was employed as meat. The meat was cut into halves, with a half being used in Example 3 and a remaining half being used in Comparative Example 3 (which will be described later). Fungi were taken at time points of 7 days, 10 days, and 14 days after ion irradiation, and six surfaces were evaluated based on an average value of n4, with one surface being defined as n1 and a maximum value and a minimum value for the numbers of fungi (CFU/cm²) obtained by division by an area being excluded. Change over time in number of fungi was observed as in Example 1 except for points other than described above.

### Comparative Example 3

Change over time in number of fungi was observed as in Example 1 except for absence of ion irradiation.

FIG. 3 is a graph showing comparison between a case that positive ions and negative ions were emitted from six locations as surrounding from above, below, front, rear, left, and right and meat was placed and stored for a certain period of time at a position where the positive ions and the negative ions were at a high concentration (Example 3: black circle) and a case that positive ions and negative ions were not emitted (Comparative Example 3: white square), with (a) showing a plot at each time point and (b) showing an index calculated from results in FIG. 3 (a). In FIG. 3, the ordinate represents an average number of fungi Log (CFU/cm²), the abscissa in FIG. 3 (a) represents each time point of an initial stage, after 7 days, after 10 days, and after 14 days, and the abscissa in FIG. 3 (b) represents days which elapsed.

Table 5 shows an average number of fungi (CFU/cm²) and a ratio of removal at each time point in Example 3 and Comparative Example 3, Table 6 shows the number of fungi (CFU/cm²) for each irradiated surface, and Table 7 shows an expected value for the number of fungi (CFU/cm²) calculated from an approximation line shown in FIG. 3 (b).

TABLE 5

| | | Initial | After 7 | After 10 | After 14 |
|---|---|---|---|---|---|
| | | Stage | Days | Days | Days |
| The Average | Example | 5.9E+02 | 2.5E+05 | 1.4E+06 | 5.0E+06 |
| Number of | 3 | | | | |
| Fungi | | | | | |
| (CFU/cm²) | | | | | |
| | Compar- | 5.9E+02 | 1.2E+06 | 1.0E+06 | 2.5E+08 |
| | ative | | | | |
| | Example | | | | |
| | 3 | | | | |

| | | | | |
|---|---|---|---|---|
| Ratio of Removal (%) | — | 79.5 | −39.7 | 98.0 |

TABLE 6

| | | After 7 Days | | After 10 Days | | After 14 Days | |
|---|---|---|---|---|---|---|---|
| | Initial | | Comparative | | Comparative | | Comparative |
| | Stage | Example 3 | Example 3 | Example 3 | Example 3 | Example 3 | Example 3 |
| Surface 1 | 6.1E+01 | 7.0E+04 | 1.0E+05 | 5.4E+05 | 6.4E+05 | 1.5E+06 | 7.6E+06 |
| Surface 2 | 4.7E+03 | 1.1E+06 | 3.5E+06 | 3.2E+06 | 2.9E+06 | 4.1E+06 | 2.1E+08 |
| Surface 3 | 3.3E+02 | 9.9E+04 | 9.2E+04 | 5.3E+05 | 3.2E+05 | 7.2E+08 | 3.7E+08 |
| Surface 4 | 1.8E+02 | 6.6E+05 | 3.7E+06 | 1.4E+06 | 1.1E+06 | 6.5E+06 | 3.9E+08 |
| Surface 5 | 1.8E+02 | 1.7E+05 | 4.0E+05 | 4.7E+06 | 1.8E+06 | 3.9E+06 | 1.7E+07 |
| Surface 6 | 1.7E+03 | 8.4E+04 | 9.7E+05 | 4.3E+05 | 4.5E+05 | 5.4E+06 | 5.8E+08 |
| n4 | 5.9E+02 | 2.5E+05 | 1.2E+06 | 1.4E+06 | 1.0E+06 | 5.0E+06 | 2.5E+08 |
| Average | | | | | | | |

TABLE 7

| Days Elapsed | Example 3 | Comparative Example 3 |
|---|---|---|
| 0 | 1.1E+03 | 7.3E+02 |
| 1 | 2.0E+03 | 1.7E+03 |
| 2 | 4.0E+03 | 4.2E+03 |
| 3 | 7.7E+03 | 1.0E+04 |
| 4 | 1.5E+04 | 2.4E+04 |
| 5 | 2.9E+04 | 5.8E+04 |
| 6 | 5.6E+04 | 1.4E+05 |
| 7 | 1.1E+05 | 3.4E+05 |
| 8 | 2.1E+05 | 8.1E+05 |
| 9 | 4.1E+05 | 2.0E+06 |
| 10 | 8.0E+05 | 4.7E+06 |
| 11 | 1.6E+06 | 1.1E+07 |
| 12 | 3.0E+06 | 2.7E+07 |
| 13 | 5.9E+06 | 6.5E+07 |
| 14 | 1.1E+07 | 1.6E+08 |
| 15 | 2.2E+07 | 3.8E+08 |
| 16 | 4.3E+07 | 9.1E+08 |
| 17 | 8.3E+07 | 2.2E+09 |
| 18 | 1.6E+08 | 5.3E+09 |
| 19 | 3.1E+08 | 1.3E+10 |
| 20 | 6.1E+08 | 3.0E+10 |

As is clear from results shown in FIG. 3, when meat was irradiated with positive ions and negative ions, not much difference from a case without irradiation was observed in the initial stage, however, a difference in average number of fungi was noticeable as days elapsed. It can be concluded from these results that, by irradiating meat with positive ions and negative ions, growth of fungi adhering to the surface of meat was suppressed and the difference in number of fungi from a case without irradiation with positive ions and negative ions became noticeable with lapse of days (representation in Log is provided on the ordinate in FIG. 3 and difference in digits indicates a significant difference).

### REFERENCE SIGNS LIST

1 ion irradiation apparatus; 2 accommodation portion; 2a bottom surface of accommodation portion; 3a, 3b, 3c ion generation portion; 4 food requiring storage by refrigeration; 11 ion irradiation apparatus; 12a, 12b, 12c section; 13 door; 14 ion generation portion; 15 tray-like article; 16 food requiring storage by refrigeration; 17 caster; 21 ion irradiation apparatus; 22 accommodation portion; 23 ion generation portion; 24 food requiring storage by refrigeration; 25 terminal; 26 article like wheeled platform; 26a placement surface of article like wheeled platform; 27 electric cord; 28 terminal on side of article like wheeled platform; 29 caster; 31 ion irradiation apparatus; 32 accommodation portion; 32a, 32b, 32c, 32d, 32e, 32f region; 33a, 33b, 33c, 33d, 33e, 33f transportation apparatus; 41 ion irradiation apparatus; 42 examination region; 43 preparatory irradiation area; 51 ion irradiation apparatus; 52 accommodation portion; 53 lid portion; 54 ion generation portion; 54a ion outlet; 55 meat; 56 petri dish; 57a, 57b, 57c fungi collection rod; 58 airtight container; 61 ion irradiation apparatus; 62 accommodation portion; 63 lid portion; 64 ion generation portion; 64a ion outlet; 71 ion irradiation apparatus; 72 accommodation portion; and 73 web-like article or grid-like article.

1. A method of storing meat stored in a refrigerator or a freezer after a lump of meat is prepared into small portions, comprising irradiating the meat with positive ions and negative ions before storage in the refrigerator or the freezer.

2. The method according to claim 1, wherein
the meat before preparation into small portions is irradiated with the positive ions and the negative ions.

3. The method according to claim 1, wherein
before storage in the refrigerator or the freezer, the meat prepared into the small portions is irradiated with the positive ions and the negative ions.

4. The method according to claim 1, wherein
the positive ions and the negative ions are emitted by blowing the positive ions and the negative ions generated through discharge in atmosphere.

5. A method of extending a durable life of food requiring storage by refrigeration, by irradiating food requiring storage by refrigeration with positive ions and negative ions before storage by refrigeration.

6. A method of suppressing growth of fungi developed at a surface of food requiring storage by refrigeration, by irradiating food requiring storage by refrigeration with positive ions and negative ions before storage by refrigeration.

7. An ion irradiation apparatus for suppressing growth of fungi, comprising:
an accommodation portion capable of accommodating food requiring storage by refrigeration; and
an ion generation portion emitting positive ions and negative ions to inside of the accommodation portion,
growth of fungi developed at a surface of the food being suppressed by irradiating the food requiring storage by refrigeration with the positive ions and the negative ions.

8. An ion irradiation apparatus, comprising:
an accommodation portion capable of accommodating food requiring storage by refrigeration; and
an ion generation portion emitting positive ions and negative ions into inside of the accommodation portion,
a plurality of the ion generation portions being provided to surround inside of the accommodation portion.

9. The ion irradiation apparatus according to claim 8, wherein
two or more pairs of ion generation portions are provided, with the pair of ion generation portions being opposed to each other, so as to surround the inside of the accommodation portion.

10. The ion irradiation apparatus according to claim 8, wherein
the accommodation portion is constructed such that a bottom surface can turn.

11. The ion irradiation apparatus according to claim 8, wherein
the accommodation portion is a container-like article which can be transported with a plurality of the container-like articles being stacked, and a plurality of ion generation portions are provided to surround inside of the container-like article.

12. The ion irradiation apparatus according to claim 11, wherein
each container-like article is provided with a terminal for power supply and constructed such that when the container-like articles are stacked on an article like a wheeled platform which can electrically be connected to a power supply, each terminal is electrically connected and supplied with electricity from the power supply.

13. The ion irradiation apparatus according to claim 8, wherein
the accommodation portion contains a transportation apparatus which can transport food requiring storage by refrigeration so as to pass through a plurality of regions, and one ion generation portion or a plurality of ion generation portions is/are provided for each region so as to irradiate the food with the positive ions and the negative ions while the food is transported.

14. The ion irradiation apparatus according to claim 13, constructed such that the food is irradiated with the positive ions and the negative ions in directions different from one another in each region.

15. The ion irradiation apparatus according to claim 13, wherein
the accommodation portion has an examination region for detecting fungi adhering to a surface of food requiring storage by refrigeration, and is constructed such that the food is further irradiated with the positive ions and the negative ions when a result of examination in the examination region exceeds a predetermined reference value.
